(19) United States
(12) Patent Application Publication
(10) Pub. No.: US 2013/0217844 A1
(43) Pub. Date: Aug. 22, 2013

(54) PROCESS FOR THE POLYMERIZATION OF OLEFINS

(71) Applicants: Joachim T.M. Pater, Ferrara (IT); Simona Guidotti, Bologna (IT); Alessandro Mignogna, Bologna (IT); Giampiero Morini, Ferrara (IT); Gianni Vitale, Ferrara (IT)

(72) Inventors: Joachim T.M. Pater, Ferrara (IT); Simona Guidotti, Bologna (IT); Alessandro Mignogna, Bologna (IT); Giampiero Morini, Ferrara (IT); Gianni Vitale, Ferrara (IT)

(73) Assignee: Basell Poliolefine Italia S.r.l., Milano (IT)

(21) Appl. No.: 13/878,712

(22) PCT Filed: Oct. 17, 2011
(86) PCT No.: PCT/EP2011/068077

§ 371 Date: Apr. 10, 2013

Related U.S. Application Data
(60) Provisional application No. 61/405,374, filed on Oct. 21, 2010.

(30) Foreign Application Priority Data
Oct. 19, 2010 (EP) 1087985.6

(51) Int. Cl. C08F 4/646

(52) U.S. Cl. CPC C08F 4/646
USPC 526/123.1

(57) ABSTRACT

A process for the (co)polymerization of propylene carried out at a temperature ranging from 77 to 95° C. in the presence of a catalyst comprising the product obtained by reacting: —an organo-aluminium compound, with—-a solid catalyst component comprising Mg, Ti and electron donor compound selected from specific diolesters.

The present invention relates to a process for the production of polyolefins carried out at a relatively high temperature in the presence of a specific Ziegler-Natta polymerization catalyst.

The polymerization of olefins is an exothermic reaction and it is therefore necessary to provide means to cool the bed to remove the heat of polymerization.

In the absence of such cooling the bed would increase in temperature until, for example, the catalyst would become inactive or the bed commenced to fuse. In the fluidised bed polymerization of olefins, the preferred method for removing the heat of polymerization is by supplying to the polymerization reactor a gas, the fluidizing gas, which is at a temperature lower than the desired polymerization temperature, passing the gas through the fluidised bed to conduct away the heat of polymerization, removing the gas from the reactor and cooling it by passage through an external heat exchanger, and recycling it to the bed.

The temperature of the recycle gas can be adjusted in the heat exchanger to maintain the fluidised bed at the desired polymerization temperature. In this method of polymerising alpha olefins, the recycle gas generally comprises the monomeric olefin, optionally together with, for example, an inert diluent gas such as nitrogen and/or a gaseous chain transfer agent such as hydrogen. Thus the recycle gas serves to supply the monomer to the bed, to fluidize the bed, and to maintain the bed at the desired temperature.

It is well known that the production rate (i.e. the space time yield in terms of weight of polymer produced per unit volume of reactor space per unit time) in commercial gas fluidised bed reactors of the afore-mentioned type is restricted by the maximum rate at which heat can be removed from the reactor. The rate of heat removal can be increased in several ways, also depending on the type of polymerization technique. For example, in gas-phase fluidized bed polymerization, heat removal can be increased by increasing the velocity of the recycle gas, reducing the temperature of the recycle gas, changing the heat capacity of the recycle gas.

In liquid phase-polymerization the extent of heat removal can be increased either by lowering the temperature of the refrigerating liquid circulating in the jacketed reactor or by increasing its circulation velocity.

However, there are practical limits to the velocity of the recycle gas and of the circulating liquids which can be used in commercial practice. In particular, in fluidized bed gas-phase polymerization, beyond this limit the bed can become unstable or even lift out of the reactor in the gas stream, leading to blockage of the recycle line and damage to the recycle gas compressor or blower.

There are also limits on the extent to which the recycle gas and the circulating cooling liquid can be cooled in practice. This is primarily determined by economic considerations, and in practice is normally determined by the temperature of the industrial cooling water available on site. Refrigeration can be employed if desired, but this adds to the production costs.

It is known that the efficiency of heat removal is a function of the temperature difference between the polymerization reactor and the cooling fluid. Under these conditions, if the temperature of the cooling fluid is imposed by the climatic conditions, an improvement of the heat removal could be obtained by operating the reactor at higher polymerization temperature.

However, practical use of this possibility is impeded by the fact that the catalyst systems used industrially suffer from a pronounced decay of the polymerization activity with the increase of the temperature. It is apparent that the reduction of the polymerization activity thwarts the gain in the efficiency of heat removal when operating at higher temperature.

U.S. Pat. No. 7,388,061 discloses diolesters belonging to the formula R₁—CO—O—CR₃R₄-A-CR₅R₆—O—CO—R₂ in which R₁ and R₂ groups, which may be identical or different, can be substituted or unsubstituted hydrocarbyl having 1 to 20 carbon atoms, R₃-R₆ groups, which may be identical or different, can be selected from the group consisting of hydrogen, halogen or substituted or unsubstituted hydrocarbyl having 1 to 20 carbon atoms, R₁-R₆ groups optionally contain one or more hetero-atoms replacing carbon, hydrogen atom or the both, said hetero-atom is selected from the group consisting of nitrogen, oxygen, sulfur, silicon, phosphorus and halogen atom, two or more of R₃-R₆ groups can be linked to form saturated or unsaturated monocyclic or polycyclic ring; A is a single bond or bivalent linking group with chain length between two free radicals being 1-10 atoms, wherein said bivalent linking group is selected from the group consisting of aliphatic, alicyclic and aromatic bivalent radicals, and can carry C1-C20 linear or branched substituents; one or more of carbon atoms and/or hydrogen atoms on above-mentioned bivalent linking group and substituents can be replaced by a hetero-atom selected from the group consisting of nitrogen, oxygen, sulfur, silicon, phosphorus, and halogen atom, and two or more said substituents on the linking group as well as above-mentioned R₃-R₆ groups can be linked to form saturated or unsaturated monocyclic or polycyclic ring.

The examples reported in the document show, in general, capability to produce polymers with a broad molecular weight distribution. The performances of the catalyst in terms of polymerization activity and stereospecificity range from very poor (see example 68 and 86) to good. All the propylene polymerization runs have been carried out at 70° C. No information are available at higher temperatures for propylene polymerization. However, in examples 105 and 106 polymerization of ethylene is carried out at 85° C. using the same catalysts of examples 95 and 96 described for propylene polymerization at 70° C. The ethylene polymerization at 85° C. showed results in terms of polymerization activity that are by far lower than those of propylene polymerization at 70° C.

Moreover, in the international patent application WO2009/085649 it is suggested to use diolesters of the type disclosed in U.S. Pat. No. 7,388,061 for the preparation of catalysts components to be used in combination with aluminum alkyl cocatalysts, selectivity control agents, and optionally, certain activity limiting agents in order to produce self-extinguishing catalyst compositions having reduced activity at temperature higher than 70° C. The polymerization examples carried out in hydrocarbon slurry indicate that passing from a polymerization temperature of 67° C. to a polymerization temperature of 100° C. the activity drops to 46% of the original value thus indicating a substantial decay.

Surprisingly, it has been found that a specific subclass of diolesters when used in the polymerization of propylene in a certain range of temperatures does not show decay, but on the contrary, shows an increase of the polymerization activity. Therefore, these catalysts make the polymerization process at high temperature much more effective because of more efficient heat removal and higher polymerization activity.

Hence, it is an object of the present invention a process for the (co)polymerization of propylene carried out at a temperature ranging from 77 to 95° C. in the presence of a catalyst comprising the product obtained by reacting:
an organo-aluminium compound, with
   a solid catalyst component comprising Mg, Ti and electron donor compound of the following formula (A)

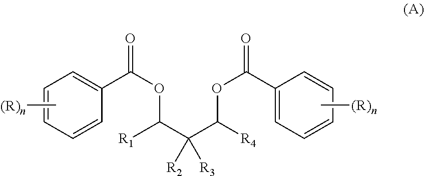

in which R₁-R₄ groups, equal to or different from each other, are hydrogen or C₁-C₁₅ hydrocarbon groups, optionally containing an heteroatom selected from halogen, P, S, N and Si, with the proviso that R₁ and R₄ are not simultaneously hydrogen, R groups equal to or different from each other, are selected from C₁-C₁₅ hydrocarbon groups which can be optionally linked to form a cycle and n is an integer from 0 to 5, and optionally
an external electron donor compound.

Preferably, the process is carried out at a temperature ranging from 80 to 95° C. more preferably from higher than 80 to 95° C. and especially from higher than 80 to 90° C. and very especially from higher than 80 to 88° C.

Preferably, in the electron donor of formula (A), R₁ and R₄ independently are selected from C₁-C₁₅ alkyl groups, C₆-C₁₄ aryl groups, C₃-C₁₅ cycloalkyl groups, and C₇-C₁₅ arylalkyl or alkylaryl groups. More preferably, R₁ and R₄ are selected from C₁-C₁₀ alkyl groups and even more preferably from C₁-C₅ alkyl groups in particular methyl.

Preferably, in the electron donor of formula (A) R₂-R₃ groups independently are selected from hydrogen, C₁-C₁₅ alkyl groups, C₆-C₁₄ aryl groups, C₃-C₁₅ cycloalkyl groups, and C₇-C₁₅ arylalkyl or alkylaryl groups. More preferably, R₂ and R₃ are selected from hydrogen or C₁-C₁₀ alkyl groups and even more preferably from hydrogen or C₁-C₅ alkyl groups in particular methyl. In one preferred embodiment, hydrogen and methyl are preferred. In one particular embodiment both R₂ and R₃ are hydrogen.

Preferably, in the electron donor of formula (A), R groups are selected from C₁-C₁₅ alkyl groups, C₆-C₁₄ aryl groups, C₃-C₁₅ cycloalkyl groups, and C₇-C₁₅ arylalkyl or alkylaryl groups.

More preferably, R are selected from C₁-C₁₀ alkyl groups and even more preferably from C₁-C₅ alkyl groups. Among them particularly preferred are methyl, ethyl, n-propyl and n-butyl. The index n can vary from 0 to 5 inclusive, preferably it ranges from 1 to 3 and more preferably is 1. When n is 1, the substituent R is preferably in position 4 of the benzoate ring.

Moreover, in the electron donor of formula (A), preferred structures are those in which simultaneously R₁ and R₄ are methyl, R₂ and R₃ are hydrogen and n is 1 and the R groups, which are in position 4 of the benzene ring are methyl, ethyl, n-propyl or n-butyl.

Non limiting examples of structures (A) are the following: 2,4-pentanediol dibenzoate, 3-methyl-2,4-pentanediol dibenzoate, 3-ethyl-2,4-pentanediol dibenzoate, 3-n-propyl-2,4-pentanediol dibenzoate, 3-i-propyl-2,4-pentanediol dibenzoate, 3-n-butyl-2,4-pentanediol dibenzoate, 3-i -butyl-2,4-pentanediol dibenzoate, 3-t-butyl-2,4-pentanediol dibenzoate, 3-n-pentyl-2,4-pentanediol dibenzoate, 3-i-pentyl-2,4-pentanediol dibenzoate, 3-cycl op entyl-2,4-pentanediol dibenzoate, 3-cyclohexyl-2,4-pentanediol dibenzoate, 3-phenyl-2,4-pentanediol dibenzoate, 3-(2-naphtyl)-2,4-pentanediol dibenzoate, 3-allyl-2,4-pentanediol dibenzoate, 3,3-dimethyl-2,4-pentanediol dibenzoate, 3-ethyl-3-methyl-2,4-pentanediol dibenzoate, 3-methyl-3-i-propyl-2,4-pentanediol dibenzoate, 3,3-diisopropyl-2,4-pentanediol dibenzoate, 3-i-pentyl-2-i-propyl-2,4-pentanediol dibenzoate, 3,5-heptanediol dibenzoate, 4,6-nonanediol dibenzoate, 2,6-dimethyl-3,5-heptanediol dibenzoate, 5,7-undecanediol dibenzoate, 2,8-dimethyl-4,6-nonanediol dibenzoate, 2,2,6,6,tetramethyl-3,5-hetanediol dibenzoate, 6,8-tridecanediol dibenzoate, 2,10-dimethyl-5,7-undecanediol dibenzoate, 1,3-dicyclopentyl-1,3-propanediol dibenzoate, 1,3-dicyclohexyl-1,3-propanediol dibenzoate, 1,3-diphenyl-1,3-propanediol dibenzoate, 1,3-bis(2-naphtyl)-1,3-propanediol dibenzoate, 2,4-hexanediol dibenzoate, 2,4-heptanediol dibenzoate, 2-methyl-3,5-hexanediol dibenzoate, 2,4-octanediol dibenzoate, 2-methyl-4,6-heptanediol dibenzoate, 2,2-dimethyl-3,5-hexanediol dibenzoate, 2-methyl-5,7-octanediol dibenzoate, 2,4-nonanediol dibenzoate, 1-cyclopentyl-1,3-butanediol dibenzoate, 1-cyclohexyl-1,3-butanediol dibenzoate, 1-phenyl-1,3-butanediol dibenzoate, 1-(2-naphtyl)-1,3-butanediol dibenzoate, 2,4-pentanediol-bis(4-methylbenzoate), 2,4-pentanediol-bis(3-methylbenzoate), 2,4-pentanediol-bis(4-ethylbenzoate), 2,4-pentanediol-bis(4-n-propylbenzoate), 2,4-pentanediol-bis(4-n-butylbenzoate), 2,4-pentanediol-bis(4-i-propylbenzoate), 2,4-pentanediol-bis(4-i -butylbenzoate), 2,4-pentanediol-bis(4-t-butylbenzoate), 2,4-pentanediol-bis(4-phenylbenzoate), 2,4-pentanediol-bis(3,4-dimethylbenzoate), 2,4-pentanediol-bis(2,4,6-trimethylbenzoate), 2,4-pentanediol-bis(2,6-dimethylbenzoate), 2,4-pentanediol-di-(2-naphthoate), 3-methyl-2,4-pentanediol-bis(4-n-propylbenzoate), 3-i-pentyl-2,4-pentanediol-bis(4-n-propylbenzoate), 1,1,1,5,5,5-hexafluoro-2,4-pentanediol-bis(4-ethylbenzoate), 1,1,1-trifluoro-2,4-pentanediol-bis(4-ethylbenzoate), 1,3-bis(4-chlorophenyl)-1,3-propanediol-bis(4-ethylbenzoate), 1-(2,3,4,5,6-pentafluorophenyl)-1,3-butanediol-bis(4-ethylbenzoate), 1,1-difluoro-4-phenyl-2,4-butandiol-bis(4-n-propylbenzoate), 1,1,1-trifluoro-5,5-dimethyl-2,4-hexanediol-bis(4-n-propylbenzoate), 1,1,1-trifluoro-4-(2-furyl)-2,4-butandiol-bis(4-n-propylbenzoate), 1,1,1-trifluoro-4-phenyl-2,4-butandiol-bis(4-n-propylbenzoate), 1,1,1-trifluoro-4-(2-thienyl)-2,4-butandiol-bis(4-n-propylbenzoate), 1,1,1-trifluoro-4-(4-chloro-phenyl)-2,4-butandiol-bis(4-n-propylbenzoate), 1,1,1-trifluoro-4-(2-naphtyl)-2,4-butandiol-bis(4-n-propylbenzoate), 3-chloro-2,4-pentanediol-bis(4-n-propylbenzoate)

As explained above, the catalyst components of the invention comprise, in addition to the above electron donors, Ti, Mg and halogen. In particular, the catalyst components comprise a titanium compound, having at least a Ti-halogen bond and the above mentioned electron donor compounds supported on a Mg halide. The magnesium halide is preferably MgCl₂ in active form which is widely known from the patent literature as a support for Ziegler-Natta catalysts. U.S. Pat. No. 4,298,718 and U.S. Pat. No. 4,495,338 were the first to describe the use of these compounds in Ziegler-Natta catalysis. It is known from these patents that the magnesium dihalides in active form used as support or co-support in components of catalysts for the polymerization of olefins are characterized by X-ray spectra in which the most intense diffraction line that appears in the spectrum of the non-active halide is diminished in intensity and is replaced by a halo whose maximum intensity is displaced towards lower angles relative to that of the more intense line. The preferred titanium compounds used in the catalyst component of the present invention are TiCl₄ and TiCl₃; furthermore, also Ti-haloalcoholates of formula Ti(OR)_{m-y}X_{y} can be used, where m is the valence of titanium, y is a number between 1 and m−1, X is halogen and R is a hydrocarbon radical having from 1 to 10 carbon atoms.

The preparation of the solid catalyst component can be carried out according to several methods. One method comprises the reaction between magnesium alcoholates or chloroalcoholates (in particular chloroalcoholates prepared according to U.S. Pat. No. 4,220,554) and an excess of TiCl₄ in the presence of the electron donor compounds at a temperature of about 80 to 135° C.

According to a preferred method, the solid catalyst component can be prepared by reacting a titanium compound of formula Ti(OR)_{m-y}X_{y}, where m is the valence of titanium and y is a number between 1 and m, preferably TiCl₄, with a magnesium chloride deriving from an adduct of formula MgCl₂.pROH, where p is a number between 0.1 and 6, preferably from 2 to 3.5, and R is a hydrocarbon radical having 1-18 carbon atoms. The adduct can be suitably prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. Examples of spherical adducts prepared according to this procedure are described in U.S. Pat. No. 4,399,054 and U.S. Pat. No. 4,469,648. The so obtained adduct can be directly reacted with Ti compound or it can be previously subjected to thermal controlled dealcoholation (80-130° C.) so as to obtain an adduct in which the number of moles of alcohol is generally lower than 3, preferably between 0.1 and 2.5. The reaction with the Ti compound can be carried out by suspending the adduct (dealcoholated or as such) in cold TiCl₄ (generally 0° C.); the mixture is heated up to 80-135° C. and kept at this temperature for 0.5-2 hours. The treatment with TiCl₄ can be carried out one or more times. The electron donor compound is preferably added during the treatment with TiCl₄. The preparation of catalyst components in spherical form are described for example in European Patent Applications EP-A-395083, EP-A-553805, EP-A-553806, EPA601525 and WO98/44001.

The solid catalyst components obtained according to the above method show a surface area (by B.E.T. method) generally between 20 and 500 m²/g and preferably between 50 and 400 m²/g, and a total porosity (by B.E.T. method) higher than 0.2 cm³/g preferably between 0.2 and 0.6 cm³/g. The porosity (Hg method) due to pores with radius up to 10.000 Å generally ranges from 0.3 to 1.5 cm³/g, preferably from 0.45 to 1 cm³/g.

The solid catalyst component has an average particle size ranging from 5 to 120 μm and more preferably from 10 to 100 p.m.

In any of these preparation methods the desired electron donor compounds can be added as such or, in an alternative way, it can be obtained in situ by using an appropriate precursor capable to be transformed in the desired electron donor compound by means, for example, of known chemical reactions such as etherification, alkylation, esterification, etc.

Regardless of the preparation method, the final amount of electron donor compounds is such that the molar ratio with respect to the MgCl₂ is from 0.01 to 1, preferably from 0.05 to 0.5. The amount of Ti atoms in the catalyst component preferably ranges from 1 to 10% wt, more preferably from 1.5 to 8% and especially from 2 to 5% with respect to the total weight of said catalyst component.

The organo aluminum compound is preferably an alkyl-Al compound. It is preferably selected from the trialkyl aluminum compounds such as for example triethylaluminum, triisobutylaluminum, tri-n-butylaluminum, tri-n-hexylaluminum, tri-n-octylaluminum. It is also possible to use mixtures of trialkylaluminum's with alkylaluminum halides, alkylaluminum hydrides or alkylaluminum sesquichlorides such as AlEt₂Cl and Al₂Et₃Cl₃.

Suitable external electron-donor compounds include silicon compounds, ethers, esters, amines, heterocyclic compounds and particularly 2,2,6,6-tetramethylpiperidine and ketones. Another class of preferred external donor compounds is that of silicon compounds of formula (R₇)ₐ(R₈)_{b}Si(OR₉)_{c}, where a and b are integers from 0 to 2, c is an integer from 1 to 4 and the sum (a+b+c) is 4; R₇, R₈, and R₉, are alkyl, cycloalkyl or aryl radicals with 1-18 carbon atoms optionally containing heteroatoms. Particularly preferred are the silicon compounds in which a is 1, b is 1, c is 2, at least one of R₇ and R₈ is selected from branched alkyl, cycloalkyl or aryl groups with 3-10 carbon atoms optionally containing heteroatoms and R₉ is a C₁-C₁₀ alkyl group, in particular methyl. Examples of such preferred silicon compounds are methylcyclohexyldimethoxysilane (C donor), diphenyldimethoxysilane, methyl-t-butyldimethoxysilane, dicyclopentyldimethoxysilane (D donor), (2-ethylpiperidinyl)t-butyldimethoxysilane, (2-ethylpiperidinyl)thexyldimethoxysilane, (3,3,3-trifluoro-n-propyl)(2-ethylpiperidinyl)dimethoxysilane, methyl(3,3,3-trifluoro-n-propyl)dimethoxysilane. Moreover, are also preferred the silicon compounds in which a is 0, c is 3, R₈ is a branched alkyl or cycloalkyl group, optionally containing heteroatoms, and R₉ is methyl. Examples of such preferred silicon compounds are cyclohexyltrimethoxysilane, t-butyltrimethoxysilane and thexyltrimethoxysilane. The external electron donor compound is used in such an amount to give a molar ratio between the organoaluminum compound and said external electron donor compound of from 0.1 to 500, preferably from 1 to 300 and more preferably from 3 to 100.

As explained before carrying out the polymerization process with the described catalyst at relatively high temperature is beneficial for both liquid phase polymerization and gas-phase polymerization.

The liquid phase polymerization can be carried out for example in slurry using as diluent a liquid inert hydrocarbon, or in bulk using the liquid monomer (propylene) as a reaction medium, or in solution using either monomers or inert hydrocarbons as solvent for the nascent polymer. The liquid phase polymerization can be carried out in various types of reactors such as continuous stirred tank reactors, loop reactors or plug-flow ones.

The gas-phase polymerization can be carried out operating in one or more fluidized or mechanically agitated bed reactors. Also, it can be carried out in a gas-phase reactor comprising two interconnected polymerization zones one of which, working under fast fluidization conditions and the other in which the polymer flows under the action of gravity.

When the polymerization is carried out in gas-phase the operating pressure is generally between 0.5 and 10 MPa, preferably between 1 and 5 MPa. In the bulk polymerization the operating pressure is generally between 1 and 6 MPa preferably between 1.5 and 4 MPa.

Bulk polymerization in liquid monomer and gas-phase polymerization is highly preferred. The catalyst of the present invention can be used as such in the polymerization process by introducing it directly into the reactor. In the alternative, the catalyst can be pre-polymerized before being introduced into the first polymerization reactor. The term pre-polymerized, as used in the art, means a catalyst which has been subject to a polymerization step at a low conversion degree. According to the present invention a catalyst is considered to be pre-polymerized when the amount the polymer produced is from about 0.1 up to about 1000 g per gram of solid catalyst component.

The pre-polymerization can be carried out with propylene or other olefins. In particular, it is especially preferred pre-polymerizing ethylene or mixtures thereof with one or more α-olefins in an amount up to 20% by mole. Preferably, the conversion of the pre-polymerized catalyst component is from about 0.2 g up to about 500 g per gram of solid catalyst component.

The pre-polymerization step can be carried out at temperatures from 0 to 60° C. preferably from 5 to 50° C. in liquid or gas-phase. The pre-polymerization step can be performed in-line as a part of a continuous polymerization process or separately in a batch process. When using batch pre-polymerization, it is preferred prepolymerizing the catalyst of the invention with ethylene in order to produce an amount of polymer ranging from 0.5 to 20 g per gram of catalyst component.

As explained, the process is for the (co)polymerization of propylene optionally in mixture with other olefins. It can be used for the production of crystalline propylene homo or copolymers containing up to 10% of comonomer such as ethylene, butane-1, or hexane-1, or for the production of impact resistant propylene polymer compositions comprising a relatively high crystalline propylene polymer fraction insoluble in xylene at 25° C., and a relatively low crystallinity copolymer fraction being soluble in xylene at 25° C.

The following examples are given in order to better illustrate the invention without limiting it.

### Characterization

### Determination of X.I.

2.5 g of polymer and 250 ml of o-xylene were placed in a round-bottomed flask provided with a cooler and a reflux condenser and kept under nitrogen. The obtained mixture was heated to 135° C. and was kept under stirring for about 60 minutes. The final solution was allowed to cool to 25° C. under continuous stirring, and the insoluble polymer was then filtered. The filtrate was then evaporated in a nitrogen flow at 140° C. to reach a constant weight. The content of said xylene-soluble fraction is expressed as a percentage of the original 2.5 grams and then, by difference, the X.I. %.

### Melt Flow Rate (MFR)

The melt flow rate MIL of the polymer was determined according to ISO 1133 (230° C., 2.16 Kg)

### EXAMPLES

### Procedure for Preparation of the Spherical Adduct

An initial amount of microspheroidal MgCl₂.2.8C₂H₅OH was prepared according to the method described in Example 2 of WO98/44009, but operating on larger scale. The solid adduct so obtained is called Adduct A. Part of this solid was then subject to thermal dealcoholation at increasing temperatures from 30 to 130° C. and operating in nitrogen flow until reaching an alcohol content of 50% wt. The obtained solid is called Adduct B. A part of this solid is further dealcoholated under nitrogen flow, until reaching 46% wt of ethanol. This solid is called Adduct C.

### Preparation of the Solid Catalyst Component 1—(ID=2,4-pentanediol dibenzoate)

Into a 500 ml round bottom flask, equipped with mechanical stirrer, cooler and thermometer 250 ml of TiCl₄ were introduced at room temperature under nitrogen atmosphere. After cooling to 0° C., while stirring, 12.5 g of Adduct B and 2,4-pentanediol dibenzoate (at Mg/ID=8 molar) were sequentially added into the flask. The temperature was raised to 120° C. and maintained for 2 hours. Thereafter, stirring was stopped, the solid product was allowed to settle and the supernatant liquid was siphoned off maintaining the temperature at 120° C. After the supernatant was removed, additional fresh TiCl₄ was added to reach the initial liquid volume again. The mixture was heated to 120° C. again and kept at this temperature for 1 hour. Stirring was stopped again, the solid was allowed to settle and the supernatant liquid was siphoned off. The titanation step was repeated 1 more time at 120° C. for 1 hour. After siphoning off the liquid phase of the third titanation, the solid was washed with anhydrous hexane six times (6×100 ml) in temperature gradient down to 60° C. and one time (100 ml) at room temperature. The obtained solid was then dried under vacuum, analyzed and used in the polymerization of propylene. The solid contains 3.6% wt of Ti and 9.4% wt of ID.

### Preparation of the Solid Catalyst Component 2 (ID=2,4-pentanediol bis(4-n-propylbenzoate))

The preparation as described above for solid catalyst component 1 was repeated, but now 2,4-pentanediol bis(4-n-propylbenzoate) was used as internal electron donor, at Mg/ID molar ratio equal to 9.5. The obtained solid contained 3.7% wt Ti and 10.4% wt of ID.

### Preparation of the Solid Catalyst Component 3 (ID=3-methyl-2,4-pentanediol dibenzoate)

The preparation as described above for solid catalyst component 1 was repeated, but now 3-methyl-2,4-pentanediol dibenzoate was used as internal electron donor. The obtained solid contained 4.1% wt Ti and 4.7% wt of ID.

### Preparation of the Solid Catalyst Component 4 (ID=2,2,4-trimethyl-1,3-pentanediol dibenzoate)

The preparation as described above for solid catalyst component 1 was repeated, with the following differences. The internal donor used now, was 2,2,4-trimethyl-1,3-pentanediol dibenzoate, at Mg/ID=6. As magnesium precursor, Adduct A was used. Only two titanation steps were applied, the first being at 100° C. for 2 hours, and the second at 120° C. for 1 hour. The obtained solid contained 4.7% wt Ti.

### Preparation of the Solid Catalyst Component 5 (Comparative. ID=2-i-pentyl-2-i-propyl-1,3-propandiol dibenzoate)

The preparation as described above for solid catalyst component 4 was repeated, with the following differences. The internal donor used now, was 2-i-pentyl-2-i-propyl-1,3-pentanediol dibenzoate, at Mg/ID=8. As magnesium precursor, Adduct B was used. The obtained solid contained 4.6% wt Ti.

### Preparation of the Solid Catalyst Component 6 (Comparative. ID=diisobutyl phthalate)

A solid catalyst component was prepared, following the description of catalyst component 1, with the following differences. As the internal donor, diisobutyl phthalate (DIBP) was used, at Mg/ID=6 molar. The preparation was done using 4 titanation steps, at 100° C., 110° C., 120° C. and 120° C. respectively. The obtained solid contained 2.6% wt Ti and 9.7% wt DIBP.

### Preparation of the Solid Catalyst Component 7 (Comparative. ID=1,3-diether)

A solid catalyst component was prepared, following the description of catalyst component 1, with the following differences. As the internal donor, 9,9-bis(methoxymethyl)-9H-fluorene was used, at Mg/ID=5 molar. The three titanation steps were done at 100° C., 110° C. and 110° C. respectively. The obtained solid contained 4.4% wt Ti and 13.2% wt of internal donor.

### Preparation of the Solid Catalyst Component 8 (Comparative. ID=succinate)

A solid catalyst component was prepared, following the description of catalyst component 1, with the following differences. As the internal donor, diethyl 2,3-diisopropylsuccinate was used, at Mg/ID=7 molar. The magnesium precursor used was the Adduct C. The three titanation steps were done at 110° C., 120° C. and 120° C. respectively. The obtained solid contained 2.7% wt Ti and 10.5% wt of internal donor.

### General Procedure for the Polymerization of Bulk Propylene

A 4 litre steel autoclave equipped with a stirrer, pressure gauge, thermometer, catalyst feeding system, monomer feeding lines and thermostating jacket, was purged with nitrogen flow at 70° C. for one hour. Then, at 30° C. under propylene flow, were charged in sequence with 75 ml of anhydrous hexane, 50 mg of AlEt₃, an amount of cyclohexylmethyldimethoxysilane (C donor) such as to have a Al/ED molar ratio off 20 and about 5 mg of solid catalyst component. The autoclave was closed; subsequently 2.0 N1 of hydrogen were added. Then, under stirring, 1.2 kg of liquid propylene was fed. The temperature was raised in five minutes to the desired temperature, and the polymerization was carried out at this temperature for two hours. At the end of the polymerization, the non-reacted propylene was removed; the polymer was recovered and dried at 70° C. under vacuum for three hours. Then the polymer was weighed and fractionated with o-xylene to determine the amount of the xylene insoluble (X.I.) fraction.

### General Procedure for the Polymerization of Propylene in Gas Phase

A lab-scale fluidized bed reactor, equipped with recirculation gas compressor, recirculation heat exchanger, and automated temperature controller was used to polymerize propylene in gas phase. The fluidized bed reactor is prepared at the desired temperature, pressure and composition, such to reach the targets values after discharging the prepolymerized catalyst into it. Target values for the polymerization are pressure of 20 barg, composed of 93.8% mole of propylene, 5% mole of propane, and 1.2% mole of hydrogen.

In a glass flask, the desired amounts of triethyl aluminum, dicyclopentyldimethoxysilane (D-donor) and solid catalyst component were charged in 100 mL of hexane. The catalyst is precontacted at room temperature for 10 minutes. Then, the content of the flask is discharged into a 1.5 L autoclave. The autoclave was closed, 100 grams of liquid propane and 40 grams of propylene were added. The catalyst was prepolymerized at 30° C. for 15 minutes.

Subsequently, the content of the autoclave is discharged into the fluidized bed reactor that was prepared as described above. The polymerization was carried out for 2 hours, while the pressure of the reactor was kept constant by feeding continuously gaseous propylene, enough to make up for the reacted monomer. After the 2 hours, the formed polymer bed is discharged, degassed and characterized.

### Examples 1-4, and Comparative Examples C1 to C6

Above described solid catalyst components were used in the bulk polymerization of propylene, using the general method described above. The catalysts were tested at two different polymerization temperatures: 70° C. and 85° C. The results of the bulk polymerizations for different solid catalyst components and temperatures are depicted in Table 1.

### Examples 5-10, and Comparative Examples C7 to C20

Above described solid catalyst components were used in the gas phase polymerization of propylene, using the general method described above. The catalysts were tested at various polymerization temperatures. The results of the polymerizations in the fluidized bed reactor for different solid catalyst components and temperatures are depicted in Table 2.

TABLE 1
Examples of bulk polymerization of propylene

| | | T | Mileage | | XI | MIL |
|---|---|---|---|---|---|---|
| Example | Catalyst/Donor | ° C. | kg/g | % | wt % | g/10′ |
| C1 | Catalyst 1 | 70 | 116 | 100 | 94.2 | 3.9 |
| 1 | | 85 | 133 | 115 | 96.1 | 4.0 |
| C2 | Catalyst 2 | 70 | 150 | 100 | 97.0 | 1.6 |
| 2 | | 85 | 174 | 116 | 98.2 | 1.1 |
| C3 | Catalyst 3 | 70 | 105 | 100 | 91.3 | 8.0 |
| 3 | | 85 | 130 | 124 | 93.0 | 5.5 |
| C4 | Catalyst 4 | 70 | 36 | 100 | 91.0 | 7.9 |
| 4 | | 85 | 45 | 124 | 92.6 | 4.8 |
| C5 | Catalyst 5 | 70 | 16 | 100 | 88.2 | 11 |
| C6 | | 85 | 17 | 104 | 86.3 | 16 |

TABLE 2
Examples of gas phase polymerization of propylene

| | | T | Mileage | XI | MIL |
|---|---|---|---|---|---|
| Example | Catalyst/Donor | ° C. | kg/g | Wt % | g/10′ |
| C7 | Catalyst 2 | 70 | 60 | 98.1 | 1.8 |
| 5 | (2,4-pentanediol bis(4-n- | 75 | 60 | 98.1 | 1.8 |
| 6 | propylbenzoate)) | 80 | 58 | 98.4 | 3.5 |
| 7 | | 85 | 63 | 98.5 | 3.1 |
| 8 | | 90 | 49 | 98.2 | 2.4 |
| 9 | | 95 | 26 | 98.0 | 8.2 |
| C8 | | 100 | 25 | 97.6 | 11 |
| C9 | Catalyst 6 | 70 | 30 | 98.4 | 2.4 |
| C10 | (Diisobutylphthalate) | 85 | 24 | 98.5 | 3.7 |
| C11 | | 90 | 19 | 98.5 | 5.0 |
| C12 | | 100 | 11 | 98.3 | 11 |
| C13 | Catalyst 7 | 70 | 31 | 98.4 | 6.3 |
| C14 | (9,9-bis(methoxymethyl)-9H- | 80 | 26 | 98.4 | 7.4 |
| C15 | fluorene) | 85 | 22 | 98.4 | 7.4 |
| C16 | | 90 | 11 | 98.2 | 13.3 |
| C17 | | 100 | 7 | 97.7 | 15 |
| C18 | Catalyst 8 | 70 | 31 | 98.1 | 1.5 |
| C19 | (diethyl 2,3- | 85 | 26 | 98.4 | 3.2 |
| C20 | diisopropylsuccinate) | 100 | 11 | 98.1 | 0.9 |

1. A process for the (co)polymerization of propylene carried out at a temperature ranging from 77 to 95° C. in the presence of a catalyst comprising the product obtained by reacting:
an organo-aluminium compound, with
a solid catalyst component comprising Mg, Ti and electron donor compound of the following formula (A) 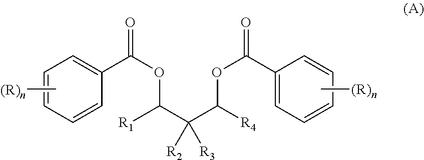
in which R₁-R₄ groups, equal to or different from each other, are hydrogen or C1-C15 hydrocarbon groups, optionally containing a heteroatom selected from halogen, P, S, N and Si, with the proviso that R1 and R4 are not simultaneously hydrogen, R groups equal to or different from each other, are selected from C1-C15 hydrocarbon groups which can be optionally linked to form a cycle and n is an integer from 0 to 5, and optionally
an external electron donor compound.

2. The process according to claim 1 in which the process is carried out at a temperature ranging from 77 to 100° C.

3. The process according to claim 2 in which the process is carried out at a temperature ranging from 80 to 95° C.

4. The process according to claim 1 in which in the donor of formula (A) R1 and R4 are independently selected from C1-C15 alkyl groups, C6-C14 aryl groups, C3-C15 cycloalkyl groups, and C7-C15 arylalkyl or alkylaryl groups.

5. The process according to claim 1 in which R1 and R4 are selected from C1-C10 alkyl groups.

6. The process according to claim 1 in which R2-R3 groups independently are selected from hydrogen, C1-C15 alkyl groups, C6-C14 aryl groups, C3-C15 cycloalkyl groups, and C7-C15 arylalkyl or alkylaryl groups.

7. The process according to claim 1 in which R2-R3 groups independently are selected from hydrogen or C1-C10 alkyl groups.

8. The process according to claim 1 in which both R2 and R3 groups, independently, are hydrogen.

9. The process according to claim 1 in which R groups are selected from C1-C15 alkyl groups, C6-C14 aryl groups, C3-C15 cycloalkyl groups, and C7-C15 arylalkyl or alkylaryl groups.

10. The process according to claim 1 in which R groups are selected from C1-C5 alkyl groups.

11. The process according to claim 1 in which the index n ranges from 1 to 3.

12. The process according to claim 1 in which n is 1 and the substituent R is in position 4 of the benzoate ring.

13. The process according to claim 1 in which the organo aluminum compound is an alkyl-Al compound.

14. The process according to claim 1 in which the external electron donor is selected from silicon compounds of formula (R₇)ₐ(R₈)_{b}Si(OR₉)_{c}, where a and b are integers from 0 to 2, c is an integer from 1 to 4 and the sum (a+b+c) is 4; R₇, R₈, and R₉, are alkyl, cycloalkyl or aryl radicals with 1-18 carbon atoms optionally containing heteroatoms.

15. The process according to claim 1 carried out in one or more gas-phase reactors.
